(19) United States
(12) Patent Application Publication
(10) Pub. No.: US 2025/0334822 A1
(43) Pub. Date: Oct. 30, 2025

(54) ACTUATOR FOR FREE-ANGLE ROTATION FOR OPTICAL IMAGE STABILIZATION (OIS) AND CONTROLLING METHOD THEREOF

(71) Applicant: Huawei Technologies Co., Ltd., Shenzhen (CN)

(72) Inventors: Kazuya Atsuta, Tokyo (JP); Takashi Yamamoto, Tokyo (JP); Atsushi Yoneyama, Tokyo (JP)

(21) Appl. No.: 19/253,093

(22) Filed: Jun. 27, 2025

Related U.S. Application Data
(63) Continuation of application No. PCT/CN2023/082912, filed on Mar. 21, 2023.

(51) Int. Cl. G02B 27/64; G03B 5/00

(52) U.S. Cl. CPC G02B 27/646; G03B 5/00; G03B 2205/0069

(57) ABSTRACT

An actuator includes: a camera module having magnets provided on at least three sides of the four sides of the camera module; a drive holder has a bottom part, and one or more suction magnets or suction yokes are attached to the bottom part; a base having a receiving surface which has one or more suction yokes or suction magnets, and wherein the receiving surface and the bottom part of the drive holder form a sliding mechanism configured to constrain movement of the camera module; at least three driving coils fixed with respect to the base, respectively paired with the magnets for driving and position detection provided on the at least three sides of the camera module; and detection sensors fixed with respect to the base, respectively arranged at locations facing the magnets for driving and position detection provided on the at least three sides of the camera module.

### CROSS-REFERENCE TO RELATED APPLICATIONS

This application is a continuation of International Application No. PCT/CN2023/082912, filed on Mar. 21, 2023, the disclosure of which is hereby incorporated by reference in its entirety.

### TECHNICAL FIELD

Embodiments of this application generally relate to actuators for free-angle rotation and controlling methods thereof, and in particular, to actuators supporting three-axis free-angle rotation for optical image stabilization (OIS) and control methods thereof.

While embodiments of the present application are discussed in the context of OIS associated with camera modules in mobile devices such as smartphones or tablet PCs, applications of the embodiments are not limited thereto.

### BACKGROUND

In recent years, cameras mounted in mobile devices such as smartphones or tablet PCs provide increasingly high performance and advanced functionalities. Many cameras provide functionalities such as autofocusing (AF) and camera shake compensation/optical image stabilization (OIS), which facilitate taking brighter and clearer images.

A camera may include a lens module, an imaging device (image sensor), a lens driving mechanism, and a control unit. The lens module may include a lens holder that holds a lens system that includes one or more lenses. The lens holder may hold a lens barrel that holds the lens system. Light entering the lens module is focused on the image sensor by the lens system, and the image sensor detects the light and produces corresponding electric signals, which are stored in a storage unit. The control unit controls these operations.

Typically, cameras are provided with an autofocusing (AF) function and an optical image stabilization (OIS) function. Autofocusing (AF) involves moving the lens module in the direction of the optical axis (also referred to as an axial direction), thereby adjusting the focus by changing the distance between the lens and the imaging device (sensor). Optical image stabilization (OIS) is a technique used to reduce blurring of an image due to the motion of a camera. As opposed to digital image stabilization, in which image stabilization is performed by a processing unit (processor) of a camera on digital image data obtained by the imaging device (e.g., a sensor) of the camera, optical image stabilization adjusts the position of the lens relative to the sensor in order to stabilize the image captured by the imaging device (sensor) even when the camera moves during an exposure.

Camera shake compensation may be achieved by moving the lens module horizontally (in directions perpendicular to the optical axis) by an actuator for OIS. The movement of the lens module may actually be rotations about the X-axis and Y-axis perpendicular to the optical axis, and may be referred to as tilting. Such two-dimensional movements for OIS may be achieved by splitting the moving mechanism into two layers for the X-axis and Y-axis rotation (e.g., providing a first rotation mechanism to rotate the lens module around the X-axis and a second rotation mechanism to rotate the first rotation mechanism around the Y-axis). Splitting the moving mechanism into two layers may increase the size of an actuator for driving a camera module, and hence the overall size of a camera system including the actuator.

### SUMMARY

In order to meet increasing demands for more advanced functionalities in camera systems, there is a tendency to provide camera shake compensation with rotation about the Z-axis as well as rotation about the X-axis and the Y-axis. However, a moving mechanism with three layers for three-axis rotation further increases the size.

Thus, it is desirable to provide a mechanism that is not split into three layers yet achieves three-axis rotation about the X-, Y-, and Z-axes.

Further, for detection of three-dimensional rotational positions (angular positions) required for controlling such three-axis rotation, it is desired to provide a single-layer position detection mechanism that is not split into multiple layers.

Embodiments of the present application provides a three-axis rotation actuator that does not require a layered structure to provide for driving three-axis free-angle rotation of an object-to-be-rotated (e.g., a camera module) and also for detection of rotation positions of the object-to-be-rotated.

A first implementation of a first aspect of the present application provides an actuator for driving a camera module, the actuator including: a camera module including at least a lens holder, the camera module having magnets for driving and position detection provided on at least three sides of the four sides of the camera module; a drive holder for holding the camera module, wherein the drive holder has a bottom part including a generally spherical portion, and wherein one or more suction magnets or one or more suction yokes are attached to the bottom part; a base having a receiving surface with a shape corresponding to the generally spherical portion of the bottom part of the drive holder, wherein the receiving surface has one or more suction yokes for attracting the suction magnets or one or more suction magnets for attracting the suction yokes, and wherein the receiving surface and the bottom part of the drive holder form a sliding mechanism that constrains movement of the camera module to be three-axis rotation around a center of a sphere of which the generally spherical portion forms a part; at least three driving coils fixed with respect to the base, respectively paired with the magnets for driving and position detection provided on the at least three sides of the camera module, for driving the camera module for three-axis rotation; and detection sensors fixed with respect to the base, respectively arranged at locations facing the magnets for driving and position detection provided on the at least three sides of the camera module, for detecting positions of the respective magnets for driving and position detection.

A three-axis rotation mechanism as described above, with the sliding mechanism, the suction yokes, and the suction magnets as described above, can constrain movement of the camera module to be three-axis rotation around a center of a sphere of which the generally spherical portion of the drive holder forms a part without requiring members that constrain the rotation to be a single-axis rotation around a specific axis. Such members include but is not limited to an axle, members that rotatably fix two points of the object-to-be-rotated (e.g., circular or spherical holes and members that rotate therein), and a circular member that guides rotation.

A three-axis rotation mechanism as described above may be made smaller than conventional three-axis rotation mechanisms because it does not have a layered structure. A conventional layered structure may be a structure including a first rotation mechanism supporting an object-to-be-rotated (e.g., a drive holder) rotatably about a first axis, a second rotation mechanism supporting the first rotation mechanism rotatably about a second axis, and a third rotation mechanism supporting the second rotation mechanism rotatably about a third axis.

Even with a layered structure, it might be possible to increase the number of detection sensors or providing detection sensors for each layer to alleviate the disadvantages of the layered structure. However, the single-layer three-axis rotation mechanism of the present application can decrease the number of parts and reduce the size of the actuator.

Sharing magnets both for driving tilting and for detection rotational positions (that is, using at least one magnet both for driving tilting and for position detection) as described above can also decrease the number of parts and reduce the size of the actuator as compared with embodiments providing magnets for driving and magnets for position detection separately.

According to a second implementation of the first aspect of the present application based on the first implementation of the first aspect of the present application, centers of first and second magnets for driving and position detection of the magnets for driving and position detection moving with the drive holder are at point-symmetric locations with respect to the center of the sphere, and a center of a third magnet for driving and position detection of the magnets for driving and position detection is located, in a plane that includes a line segment connecting the centers of the first and second magnets for driving and position detection and that is perpendicular to a central axis of the drive holder, on a perpendicular bisector of the line segment connecting the centers of the first and second magnets for driving and position detection.

According to a third implementation of the first aspect of the present application based on the second implementation of the first aspect of the present application, the first and second magnets for driving and position detection are for rotation about a first axis and second axis perpendicular to each other, wherein a first detection sensor of the detection sensors arranged at a location facing the first magnet for driving and position detection is configured to detect a rotational position around the first axis, and wherein a second detection sensor of the detection sensors arranged at a location facing the second magnet for driving and position detection is configured to detect a rotational position around the second axis, whereby a direction of an axis connecting the centers of the first and second magnets for driving and position detection is detected two-dimensionally.

This structure provides a specific arrangement of magnets for detection and sensors to directly detect the two-dimensional rotational position of the object-to-be-rotated (e.g., a drive holder) in a single layer without relying on a layered structure.

According to a fourth implementation of the first aspect of the present application based on the third implementation of the first aspect of the present application, the third magnet for driving and position detection is for rotation about a third axis perpendicular to the first axis and the second axis, a third detection sensor of the detection sensors arranged at a location facing the third magnet for driving and position detection is configured to detect a rotational position around the third axis, whereby a rotational position of the drive holder around the axis connecting the centers of the first and second magnets for driving and position detection is detected.

This structure provides a specific arrangement of magnets for detection and sensors to directly detect the three-dimensional rotational position of the object-to-be-rotated (e.g., a drive holder) on a single level without relying on a layered structure.

According to a fifth implementation of the first aspect of the present application based on any suitable ones of the preceding implementations of the first aspect of the present application, the actuator further includes a controller configured to control rotation of the camera module so as to compensate for a change of an optical axis direction due to a change in orientation of the actuator by using three-axis rotational position information from the detection sensors and orientation information of the actuator.

This feature allows compensation for variation in the direction of the optical axis due to a change in posture of the actuator (e.g., a change in posture due to movement of a device (e.g., a camera, a mobile phone, a smartphone, etc.) in which the actuator is installed) and allows taking an image with high quality with reduced camera shake.

According to a sixth implementation of the first aspect of the present application based on the fifth implementation of the first aspect of the present application, the controller is configured to determine the orientation information based on information from a gyrosensor.

Because a gyrosensor is installed in many smartphones, determination of the orientation information based on information from a gyrosensor is advantageous in not requiring additional components.

According to a seventh implementation of the first aspect of the present application based on the sixth implementation of the first aspect of the present application, the controller is configured to determine the orientation information based on information from the gyrosensor according to an iterative formula:

$${\vec{v}}_{n + 1} = [ \text{} \begin{matrix}{n}_{1}^{2} ( 1 - cos θ ) + & {n}_{1} {n}_{2} ( 1 - cos θ ) + & {n}_{1} {n}_{3} ( 1 - cos θ ) - \\ cos θ & {n}_{3} sin θ & {n}_{2} sin θ \\ {n}_{1} {n}_{2} ( 1 - cos θ ) - & {n}_{2}^{2} ( 1 - cos θ ) + & {n}_{2} {n}_{3} ( 1 - cos θ ) + \\ {n}_{3} sin θ & cos θ & {n}_{1} sin θ \\ {n}_{1} {n}_{3} ( 1 - cos θ ) + & {n}_{2} {n}_{3} ( 1 - cos θ ) - & {n}_{3}^{2} ( 1 - cos θ ) + \\ {n}_{2} sin θ & {n}_{1} sin θ & cos θ\end{matrix} \text{} ] {\vec{v}}_{n} ,$$

wherein \vec{v}ₙ and \vec{v}ₙ₊₁ are vectors indicating an orientation of the actuator at time points n and n+1, respectively,
wherein the vector [n₁, n₂, n₃]^{T} is a unit vector in a direction of an angular velocity vector obtained from the gyrosensor, with the direction of the angular velocity vector indicating an instantaneous direction of a rotation axis, and a magnitude of the angular velocity vector indicating a magnitude of an instantaneous angular velocity about the rotation axis, wherein θ is a rotation angle from time point n to n+1.

The above formula allows iteratively calculating an exact target position (\vec{v}ₙ₊₁) of the actuator simultaneously for the three axes, based on three-axis angular velocity signals from the gyrosensor.

The three-axis angular velocity signals that can be obtained from the gyrosensor as posture information are not signals indicative of a three-axis angular velocity in an unmovable absolute coordinate system, but are signals indicative of a three-axis angular velocity in an ever-moving coordinate system of the camera itself in which the gyrosensor is installed. Exact calculation of the posture of the camera itself is made possible only by iteratively calculating with the three-axis angular velocity signals simultaneously for the three axes as described above. (When a control amplitude is very small, e.g., less than a few degrees, the above matrix formula need not be used for practical purposes, and separate calculation of an amount of rotation about each axis according to Tₛ·ω, i.e., a sampling period multiplied by an angular velocity about the axis, can be used. In other words, control of the actuator may be achieved by using the amounts of rotation Tₛ·ω without determining the orientation vector \vec{v}ₙ.) According to the simultaneous iterative calculation for the three axes as described above, a concept of crosstalk does not occur by definition in calculation of the target value (i.e., the orientation vector \vec{v}ₙ₊₁ at the next sampling period). In other words, from the principles of calculation, separate rotation axes of the driving mechanism does not need to be considered in calculating the three-dimensional target rotational position \vec{v}ₙ₊₁ at the next sampling period. This approach of the present application in calculating the target values makes possible a single-layer actuator that can freely rotate about three axes and that is free of a concept of crosstalk by definition.

According to an eighth implementation of the first aspect of the present application based on the sixth implementation of the first aspect of the present application, the controller is configured to determine the orientation information based on information from the gyrosensor according to an approximate iterative formula:

$${\vec{v}}_{n + 1} = {\vec{v}}_{n} + {T}_{s} [ \begin{matrix}{ω}_{x} \\ {ω}_{y} \\ {ω}_{z}\end{matrix} ] \times {\vec{v}}_{n}$$

wherein \vec{v}ₙ and \vec{v}ₙ₊₁ are vectors indicating an orientation of the actuator at time points n and n+1, respectively,
wherein the vector

$$[ \begin{matrix}{ω}_{x} \\ {ω}_{y} \\ {ω}_{z}\end{matrix} ]$$

is an angular velocity vector obtained from the gyrosensor, × denotes an outer product in algebraic geometry, with Tₛ indicating a time interval from time point n to n+1 and corresponding to a sampling period of the gyrosensor.

Since no trigonometric functions are used, this formula is suitable for implementation in a device with a limited processing capability such as a portable device (e.g., a camera, a mobile phone, a smartphone, or the like). In many cases, because the sampling period of the gyrosensor is short enough, the approximation holds with sufficient accuracy.

According to a ninth implementation of the first aspect of the present application based on the seventh or eighth implementation of the first aspect of the present application, the controller is an optical image stabilization (OIS) driver IC, the OIS driver IC including: driving units configured to control currents flowing through the driving coils to drive the magnets for driving and position detection; and a control unit configured to receive position information from the detection sensors and information from the gyrosensor, determine orientation information of the actuator based on the information from the gyrosensor, determine driving information based on the position information and the orientation information, and provide the driving information to the driving units.

According to a tenth implementation of the first aspect of the present application based on the ninth implementation of the first aspect of the present application, the controller further includes amplification units for amplifying signals from the detection sensors.

By physically amplifying small signals output from the sensors, high accuracy can be achieved.

According to an eleventh implementation of the first aspect of the present application based on the seventh or eighth implementation of the first aspect of the present application, each of the detection sensors is contained in a respective driver IC configured to perform both position detection and driving of the corresponding magnet for driving and position detection, and wherein the controller is configured to receive position information from the driver ICs and information from the gyrosensor, determine orientation information of the actuator based on the information from the gyrosensor, determine driving information based on the position information and the orientation information, and provide the driving information to the driver ICs.

According to a twelfth implementation of the first aspect of the present application based on any suitable ones of the preceding implementations of the first aspect of the present application, the detection sensors are Hall sensors.

Hall sensors are advantageous in providing one-dimensional position information of magnets.

According to a thirteenth implementation of the first aspect of the present application based on any suitable ones of the preceding implementations of the first aspect of the present application, the base includes ball bearings to facilitate sliding between the receiving surface and the bottom part of the drive holder.

According to a fourteenth implementation of the first aspect of the present application based on any suitable ones of the preceding implementations of the first aspect of the present application, the magnets for driving and position detection provided on at least three sides of the four sides of the camera module includes: a first magnet for driving and position detection, provided on a first side, for causing rotation about an axis perpendicular to both a normal to the first side and an optical axis of the camera module; a second magnet for driving and position detection, provided on a second side, for causing rotation about the optical axis of the camera module; and a third magnet for driving and position detection, provided on a third side, for causing rotation about an axis perpendicular to both a normal to the third side and the optical axis of the camera module.

This provides a simple and convenient structure for causing rotation about the three axes for three-dimensional rotation of an object-to-be-rotated (e.g., a drive holder).

According to a fifteenth implementation of the first aspect of the present application based on any suitable ones of the preceding implementations of the first aspect of the present application, the camera module supports the lens holder to be movable along the optical axis for autofocusing (AF), wherein at least one AF coil is provided on the lens holder, and wherein at least one AF magnet facing the at least one AF coil is provided on a housing of the camera module.

This structure allows both three-axis rotation of the camera module and AF movement within the camera module.

According to a sixteenth implementation of the first aspect of the present application based on the fifteenth implementation of the first aspect of the present application, at least one of the magnets for driving and position detection provided on the at least three sides is also used as at least one of the at least one AF magnet.

By sharing at least one magnet for both AF driving and OIS driving, the number of components and the overall size can be reduced.

According to a seventeenth implementation of the first aspect of the present application based on the fifteenth implementation of the first aspect of the present application, the magnets for driving and position detection provided on at least three sides of the four sides of the camera module are magnets for driving and position detection provided on three sides, and a magnet for driving and position detection provided on one side of the three sides is also used as an AF magnet.

According to an eighteenth implementation of the first aspect of the present application based on any suitable ones of the preceding implementations of the first aspect of the present application, another AF magnet is provided on the fourth side other than the three sides.

According to a nineteenth implementation of the first aspect of the present application based on the fifteenth implementation of the first aspect of the present application, the magnets for driving and position detection provided on at least three sides of the four sides of the camera module are magnets for driving and position detection provided on three sides, and wherein magnets for driving and position detection provided on two sides of the three sides are also used as AF magnets.

According to a twentieth implementation of the first aspect of the present application based on any suitable ones of the preceding implementations of the first aspect of the present application, the driving coils and the detection sensors are provided on a flexible printed circuit (FPC).

According to a twenty-first implementation of the first aspect of the present application based on any suitable ones of the preceding implementations of the first aspect of the present application, one or more components directly or indirectly attached to the drive holder are supplied power from a portion fixed with respect to the base via a second flexible printed circuit (FPC) attached to the drive holder, and wherein the second FPC includes one or more slits.

Slits in the FPC may reduce the reactionary force exerted by the FPC on an object-to-be-rotated (e.g., a drive holder) at the time of XYZ driving (i.e., when the object-to-be-rotated is driven in three-axis rotation).

According to a twenty-second implementation of the first aspect of the present application based on any suitable ones of the preceding implementations of the first aspect of the present application, one or more components directly or indirectly attached to the drive holder are supplied power from a portion fixed with respect to the base via one or more metal springs.

This provides an alternative embodiment that provides electric connection while allowing movement of the object-to-be-rotated (e.g., a drive holder).

According to a twenty-third implementation of the first aspect of the present application based on the twenty-first or twenty-second implementation of the first aspect of the present application, the one or more components directly or indirectly attached to the drive holder are an image sensor, the AF coil, and/or an AF sensor.

According to a twenty-fourth implementation of the first aspect of the present application based on any suitable ones of the preceding implementations of the first aspect of the present application, the camera module supports the lens holder to be movable along the optical axis for autofocusing (AF) via one or more elastic members.

According to a twenty-fifth implementation of the first aspect of the present application based on the twenty-fourth implementation of the first aspect of the present application, the one or more elastic members are leaf springs.

According to a twenty-sixth implementation of the first aspect of the present application based on any suitable ones of the preceding implementations of the twenty-fourth aspect of the present application, the one or more elastic members include a first leaf spring supporting the lens holder along the optical axis from a first side and a second leaf spring supporting the lens holder along the optical axis from a second side.

According to a twenty-seventh implementation of the first aspect of the present application based on the twenty-fourth implementation of the first aspect of the present application, the one or more elastic member is a first leaf spring supporting the lens holder along the optical axis from a first side, and wherein movement of the lens holder is constrained to a direction of the optical axis by at least two shafts.

According to a twenty-eighth implementation of the first aspect of the present application based on the twenty-fourth implementation of the first aspect of the present application, at least one of the one or more elastic member forms at least part of a path for supplying power to the camera module.

According to a twenty-ninth implementation of the first aspect of the present application based on the fifteenth implementation of the first aspect of the present application, the lens holder is supported by a top spring and a bottom spring to be movable along the optical axis for autofocusing (AF), wherein the at least one AF coil includes a first AF coil and a second AF coil, and wherein a current is caused to flow from a portion fixed with respect to the base to a second flexible printed circuit (FPC) attached to the drive holder, the bottom spring, the first AF coil, the top spring, the second AF coil, the bottom spring, and the second FPC in order.

According to a thirtieth implementation of the first aspect of the present application based on any suitable ones of the preceding implementations of the first aspect of the present application, the camera module further includes a lens and an image sensor.

A first implementation of a second aspect of the present application provides a method, performed by a controller, for controlling the actuator according to claim 1, the method including: receiving three-axis rotation position information from the detection sensors; determining a required rotation to compensate for a change of an optical axis direction due to a change in orientation of the actuator based on the three-axis rotational position information and orientation information of the actuator; and controlling rotation of the camera module based on the required rotation.

According to a second implementation of the second aspect of the present application based on the first implementation of the second aspect of the present application, the method further includes determining the orientation information based on information from a gyrosensor.

According to a third implementation of the second aspect of the present application based on the second implementations of the second aspect of the present application, the orientation information is determined based on information from the gyrosensor according to an iterative formula:

$${\vec{v}}_{n + 1} = [ \text{} \begin{matrix}{n}_{1}^{2} ( 1 - cos θ ) + & {n}_{1} {n}_{2} ( 1 - cos θ ) + & {n}_{1} {n}_{3} ( 1 - cos θ ) - \\ cos θ & {n}_{3} sin θ & {n}_{2} sin θ \\ {n}_{1} {n}_{2} ( 1 - cos θ ) - & {n}_{2}^{2} ( 1 - cos θ ) + & {n}_{2} {n}_{3} ( 1 - cos θ ) + \\ {n}_{3} sin θ & cos θ & {n}_{1} sin θ \\ {n}_{1} {n}_{3} ( 1 - cos θ ) + & {n}_{2} {n}_{3} ( 1 - cos θ ) - & {n}_{3}^{2} ( 1 - cos θ ) + \\ {n}_{2} sin θ & {n}_{1} sin θ & cos θ\end{matrix} \text{} ] {\vec{v}}_{n} ,$$

wherein \vec{v}ₙ and \vec{v}ₙ₊₁ are vectors indicating an orientation of the actuator at time points n and n+1, respectively,
wherein the vector [n₁, n₂, n₃]^{T} is a unit vector in a direction of an angular velocity vector obtained from the gyrosensor, with the direction of the angular velocity vector indicating an instantaneous direction of a rotation axis, and a magnitude of the angular velocity vector indicating a magnitude of an instantaneous angular velocity about the rotation axis, wherein θ is a rotation angle from time point n to n+1.

According to a fourth implementation of the second aspect of the present application based on the second implementations of the second aspect of the present application, the orientation information is determined based on information from the gyrosensor according to an approximate iterative formula:

$${\vec{v}}_{n + 1} = {\vec{v}}_{n} + {T}_{s} [ \begin{matrix}{ω}_{x} \\ {ω}_{y} \\ {ω}_{z}\end{matrix} ] \times {\vec{v}}_{n}$$

wherein \vec{v}ₙ and \vec{v}ₙ₊₁ are vectors indicating an orientation of the actuator at time points n and n+1, respectively,
wherein the vector

$$[ \begin{matrix}{ω}_{x} \\ {ω}_{y} \\ {ω}_{z}\end{matrix} ]$$

is an angular velocity vector obtained from the gyrosensor, × denotes an outer product in algebraic geometry, with Tₛ indicating a time interval from time point n to n+1 and corresponding to a sampling period of the gyrosensor.

According to a fifth implementation of the second aspect of the present application based on the third or fourth implementation of the second aspect of the present application, the controller is an optical image stabilization (OIS) driver IC, the OIS driver IC including: driving units configured to control currents flowing through the driving coils to drive the magnets for driving and position detection; and a control unit configured to receive position information from the detection sensors and information from the gyrosensor, determine orientation information of the actuator based on the information from the gyrosensor, determine driving information based on the position information and the orientation information, and provide the driving information to the driving units.

According to a sixth implementation of the second aspect of the present application based on the third or fourth implementation of the second aspect of the present application, each of the detection sensors is contained in a respective driver IC configured to perform both position detection and driving of the corresponding magnet for driving and position detection, and wherein the controller is configured to receive position information from the driver ICs and information from the gyrosensor, determine orientation information of the actuator based on the information from the gyrosensor, determine driving information based on the position information and the orientation information, and provide the driving information to the driver ICs.

Any feature as described in the context of the actuator of the first aspect may be combined with any suitable ones of the implementation of the second aspect of the present application. The method according to any implementation of the second aspect of the present application may provide the same or similar advantageous effects as those provided by the first aspect of the present application. Thus, details are not described again.

A third aspect of the present application provides a computer program for causing a processor, being the controller, to perform the method for controlling according to any implementation of the second aspect of the present application.

A fourth aspect of the present application provides a non-transitory computer-readable storage medium having stored thereon the computer program according to the third aspect of the present application.

A fifth aspect of the present application provides a chip including a processor configured to invoke and run a computer program, stored in a memory, for causing the processor to perform the method for controlling according any implementation of the second aspect of the present application.

A sixth aspect of the present application provides a camera system including the actuator according to any one of the implementations according to the first aspect of the present application.

A seventh aspect of the present application provides a mobile device including the camera system of the sixth aspect of the present application.

In one implementation of the seventh aspect of the present application, the mobile device is a mobile phone or a smartphone.

### BRIEF DESCRIPTION OF THE DRAWINGS

In order to help those skilled in the art to understand technical solutions in embodiments of the present application, references are made to the accompanying drawings, in which

FIG. 1 is an exploded view of an actuator including a camera module according to an embodiment of the present application;

FIG. 2 is a perspective view of an actuator including a camera module according to an embodiment of the present application;

FIG. 3 (a) is a cross-sectional view of an actuator including a camera module according to an embodiment of the present application, and FIG. 3 (b) is a partial cross-sectional view of an actuator including a camera module according to another embodiment of the present application;

FIG. 4 is a schematic cross-section diagram of a voice-coil motor (VCM) according to an embodiment of the present application;

FIG. 5 is a top view of an actuator including a camera module according to an embodiment of the present application;

FIG. 6 is a top view of an actuator including a camera module according to another embodiment of the present application;

FIG. 7 is a top view of an actuator including a camera module according to yet another embodiment of the present application;

FIG. 8 (a) is a perspective view of an actuator featuring a flexible printed circuit (FPC) according to an embodiment of the present application, and FIG. 8 (b) is a perspective view of an actuator featuring a metal spring according to an embodiment of the present application;

FIG. 9 (a) is a schematic diagram illustrating driving directions of OIS magnets according to an embodiment of the present application; FIG. 9 (b) is a schematic diagram illustrating two-dimensional movement (rotation) of a line connecting centers of two OIS magnets according to an embodiment of the present application; and FIG. 9 (c) is a schematic diagram illustrating one-dimensional vertical movement of the third OIS magnet when the two-dimensional direction of the line connecting the centers of the two OIS magnets is fixed, according to an embodiment of the present application;

FIG. 10 illustrates a rotation vector and a corresponding unit vector;

FIG. 11 illustrates rotation of an orientation vector about a rotation vector; and

FIG. 12 (a) illustrates an arrangement of components for sensing, controlling, and driving for a three-axis free rotation structure according to an embodiment of the present application; and FIG. 12 (b) illustrates an arrangement of components for sensing, controlling, and driving for a three-axis free rotation structure according to another embodiment of the present application.

Throughout the drawings, like numerals may indicate similar or corresponding parts.

### DETAILED DESCRIPTION OF ILLUSTRATIVE EMBODIMENTS

The following describes embodiments of the present application with reference to the accompanying drawings.

Cameras today typically provide functionalities for autofocusing (AF) and camera shake compensation/optical image stabilization (OIS) allowing for higher quality image taking.

Camera shake compensation may be achieved by moving the lens unit horizontally (in directions perpendicular to the optical axis) by an actuator for OIS. The movement of the lens unit may actually be rotations about the X-axis and Y-axis perpendicular to the optical axis, and may be referred to as tilting. In an embodiment, such two-dimensional movements for OIS may be achieved by splitting the moving mechanism into two layers for the X-axis and Y-axis rotation (e.g., providing a first rotation mechanism to rotate the lens unit around the X-axis and a second rotation mechanism to rotate the first rotation mechanism around the Y-axis).

In order to meet increasing demands for more advanced functionalities in camera systems, there is a tendency to provide for camera shake compensation with rotation about the Z-axis as well as rotation about the X-axis and the Y-axis. For example, according to an embodiment, three-axis rotation is achieved by a three-layer gimbal mechanism. In one example, a circular member for guiding rotation around the Z-axis is rotatably supported by a gimbal mechanism for allowing rotation around the Y-axis, which in turn is rotatably supported by another gimbal mechanism for allowing rotation around the X-axis.

However, a layered structure splitting the moving mechanism into two or three layers tends to increase the size of an actuator that drives a camera module, and hence the overall size of a camera system including the actuator. Thus, it is desirable to provide a mechanism that is not split into three layers yet achieves three-axis rotation about the X-, Y-, and Z-axes.

It should be noted that, as used herein, unless otherwise stated or indicated by context, the term “camera module” refers to a portion that is driven by operations of the actuator, as opposed to a camera system or a camera that includes the actuator. The camera module includes at least a lens holder, and an optical axis of a lens unit held by the lens holder may be referred to as an optical axis of the camera module. The term “actuator” may be used to refer to a portion that includes such a camera module driven by operations of the actuator. The term “actuator” may further be used to refer to a portion that includes a controller for controlling operations of the actuator. However, a specific location of the controller is not limited herein.

For the purpose of OIS, the lens unit is rotated to compensate for changes in posture/orientation of the camera module including the lens unit. That is, movement of the camera is detected (typically by a gyrosensor), and the lens unit is rotated by the actuator to compensate for the movement. By iteratively performing such control in rapid succession (with a short period, e.g., a period corresponding to a sampling period of the gyrosensor), the direction of the optical axis of the lens unit may be stabilized (e.g., remain fixed).

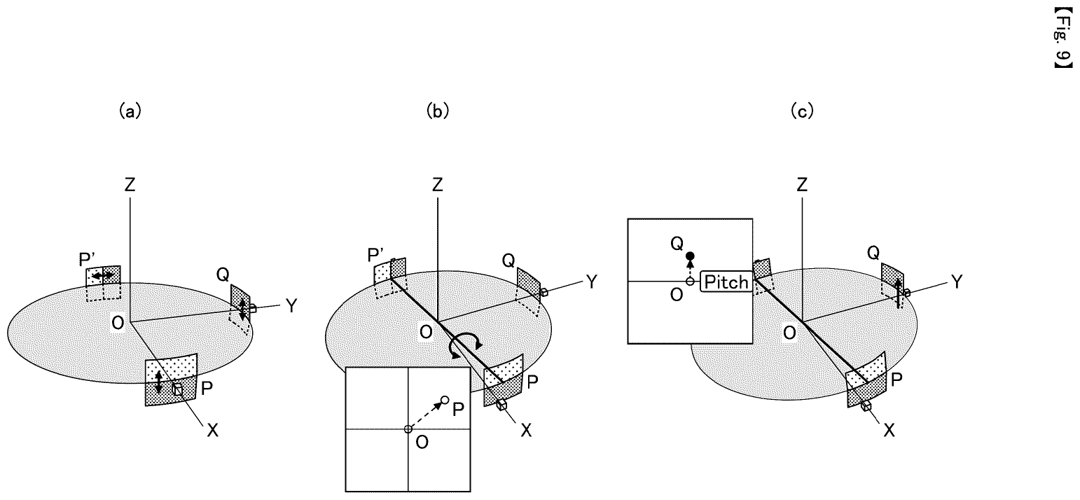

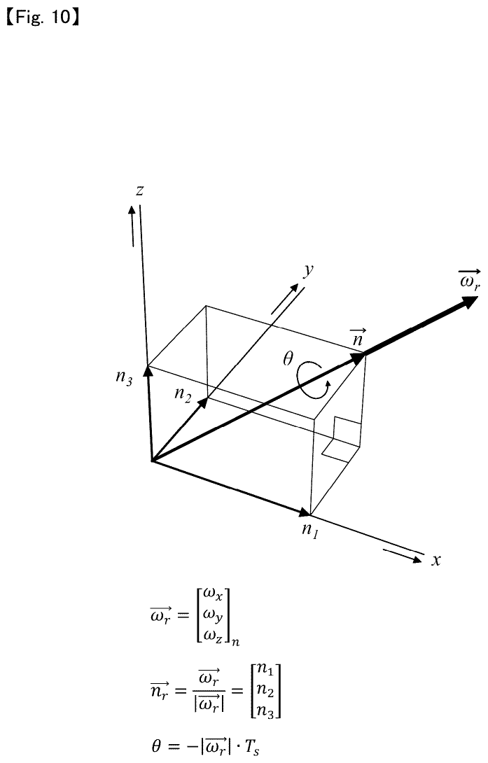

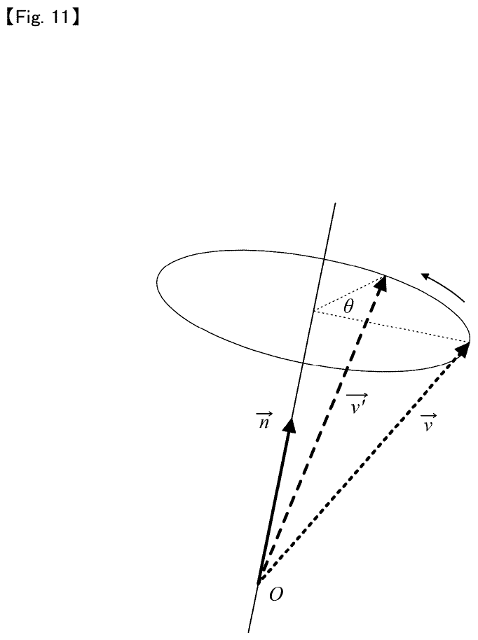

Three-axis angular velocity signals obtained from a gyrosensor as posture information for the camera are not signals indicative of a three-axis angular velocity in an unmovable absolute coordinate system, but are signals indicative of a three-axis angular velocity in an ever-moving coordinate system of the camera itself in which the gyrosensor is installed. Exact calculation of the posture of the camera based on such signals is made possible only by iterative calculation with the three-axis angular velocity signals performed simultaneously for the three axes, as described below with reference to FIG. 9, FIG. 10, and FIG. 11. When a control cycle (e.g., a sampling period of the gyrosensor) is sufficiently short, required amounts of rotation about respective axes can be obtained by multiplying the respective angular velocities about the respective axes by the sampling period, and the amounts of rotation thus separately obtained may be used to control the object-to-be-rotated (e.g., the camera module) without any need for determining the posture of the object-to-be rotated (e.g., the camera module) in the absolute coordinate system. However, with the three-axis rotation mechanism that does not rely on layered structure as provided in embodiments of the present application, the iterative calculation performed simultaneously for three axes provides for calculation of target values that is free from the concept of crosstalk by definition. In other words, a three-dimensional target rotation position at the next sampling period (i.e., an orientation vector of the camera at the next sampling period) can be determined without requiring, from the calculation principles, consideration of interrelations among multiple layered rotations of the driving mechanism. Thus, controlling of the three-axis rotation driving mechanism of the present application based on three-axis simultaneous calculation of the camera posture (orientation) allows an actuator that is single-layered and that can freely rotate about three axes without a concept of crosstalk by definition.

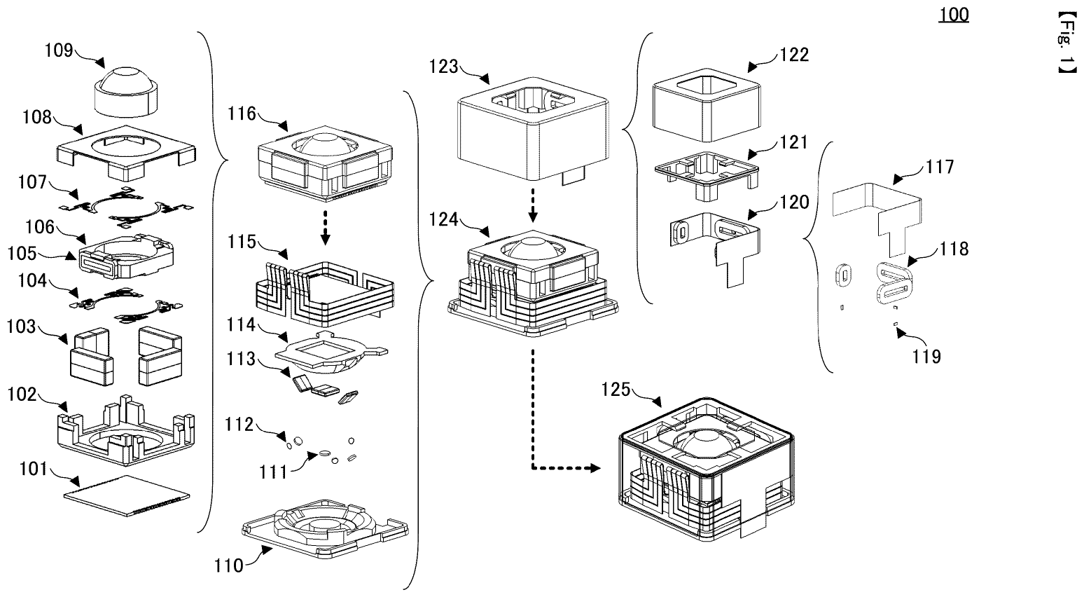

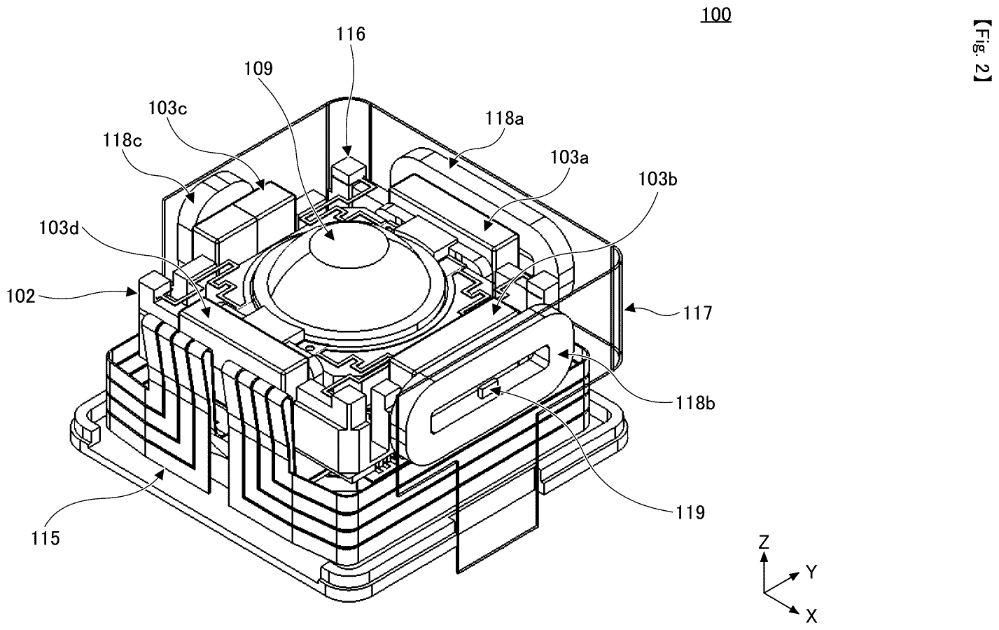

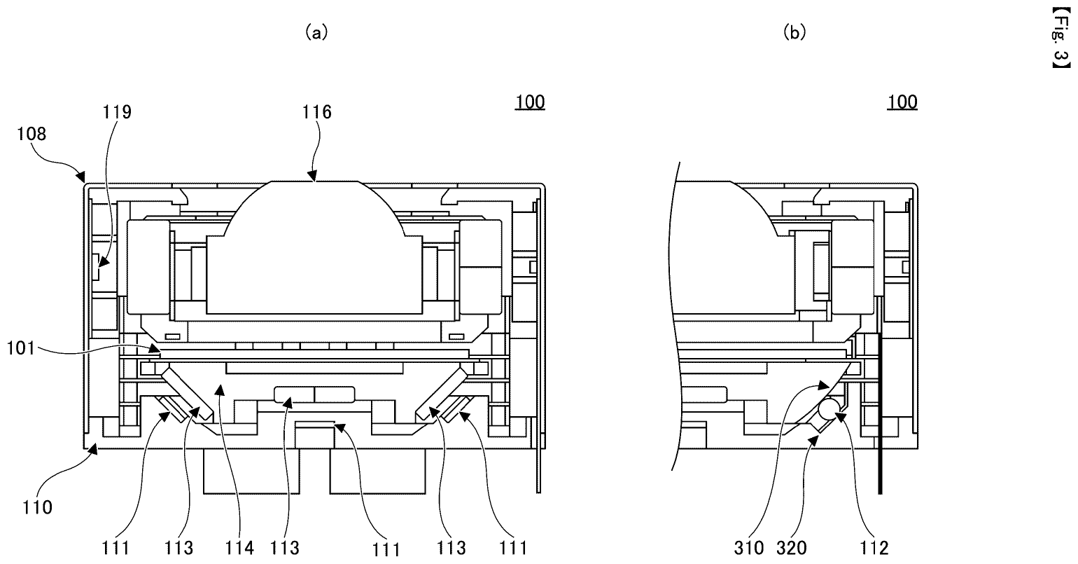

FIG. 1 is an exploded view of an actuator 100 according to an embodiment of the present application. FIG. 2 is a perspective view of the actuator 100, and FIG. 3 is a cross-sectional view of the actuator 100.

It should be noted that while the actuator is illustrated as including a camera module having a lens and an image sensor for the sake of clarity, such a camera module including a lens and an image sensor is not essential for the actuator of the present application. For the purpose of illustration, an expression “a camera module including (comprising) at least a lens holder” may be used, but such an expression also encompasses replacing such a camera module with any object-to-be-rotated. The camera module together with a member for holding the camera module (e.g., a drive holder as described below) may be referred to as the “object-to-be-rotated.”

According to the specific examples as illustrated in FIG. 1 to FIG. 3, the object-to-be-rotated is a camera module 116. The camera module 116 includes an image sensor 101, an AF base 102, a lens holder 106 movably supported via elastic members (e.g., bottom spring 104 and top spring 107) with respect to the AF base 102, and a lens 109 that is held by the lens holder 106 and that moves with the lens holder 106 along the optical axis for autofocusing (AF). The lens 109 may be a lens unit including one or more lenses. The term lens may be used interchangeably with a lens unit. The camera module 116 may also have an AF cover 108.

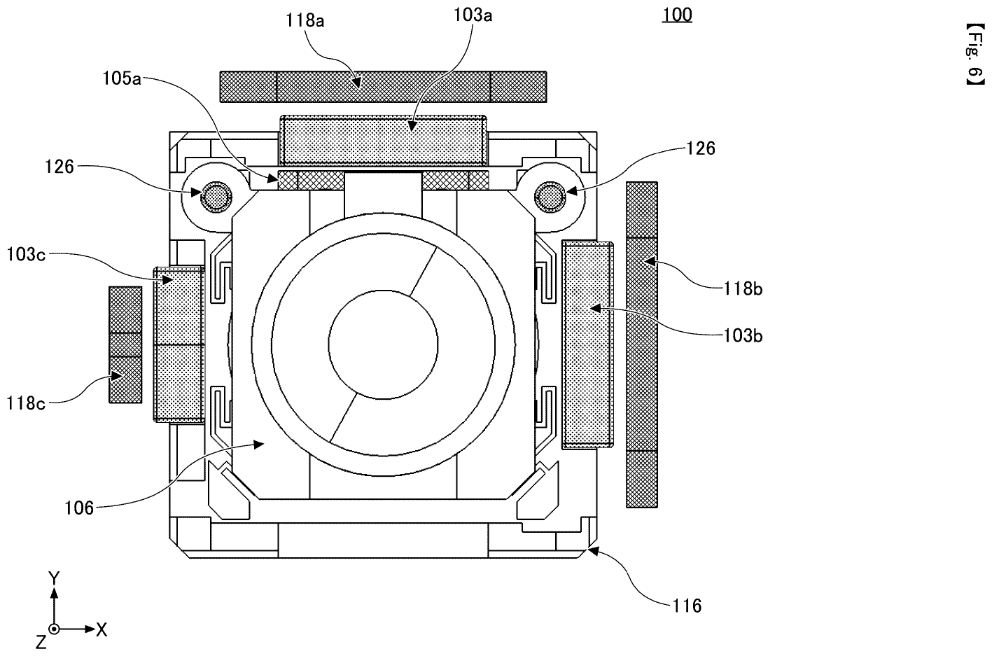

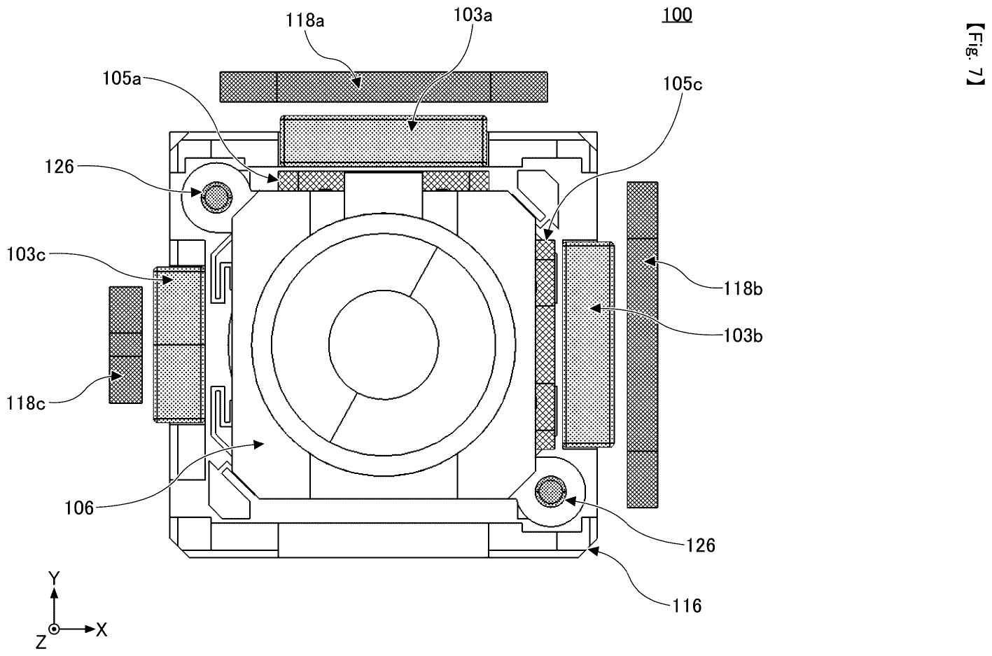

The elastic members may be leaf springs. It should be noted that the members for movably supporting the lens holder 106 are not limited to the bottom spring 104 and the top spring 107 supporting the camera module on both sides (along the optical axis). The lens holder 106 may be supported by a spring (for example, a leaf spring) on only one side. Further, movement of the lens holder may be constrained to movement along the optical axis by at least two shafts (see FIG. 6 and FIG. 7 described below).

Driving of the lens holder 106 with respect to the AF base 102 for autofocusing (AF) may be achieved by an electromagnetic interaction between the AF coils 105 (for example, flexible printed coils (FP coils)) attached to the lens holder 106 and the AF magnets 103 attached to the AF base 102. The AF coils 105 may be attached to two opposite sides among the four sides of the lens holder 106, but the present application is not limited in this respect. The AF magnets 103 are arranged so as to face the AF coils 105. One or more AF sensors (not shown) for detecting the position of the lens holder 106 for AF movement (by detecting the position of the AF magnets 103) may be provided (e.g., on the lens holder 106, in particular near the AF coils). The AF sensors may be Hall sensors, but the present application is not limited in this respect.

The AF coils 105, movable for AF, may be supplied with an electric current via the elastic members (e.g., made of metal). In one example, the AF coils 105 include a first AF coil and a second AF coil (e.g., on opposite sides of the lens holder 106 in a plane perpendicular to the optical axis), and an electric current supplied (e.g., from a sensor FPC 115) may flow through the bottom spring 104, the first AF coil, the top spring 107, the second AF coil on the opposite side, and the bottom spring 104 in this order and return to the sensor FPC 115. Use of elastic member(s) for supplying a current to the AF coils allows electrical connection while the AF coils are movable for AF. However, a specific manner of supplying a current to the AF coils is not limited to this. The present application is not limited in this respect.

It should be noted that the camera module 116 is not limited to a camera module with an AF mechanism. The camera module 116 may also be a FF (fixed focus) camera module. The present application is not limited in this respect.

For the purpose of optical image stabilization (OIS), OIS magnets 103 for causing tilting of the camera module may be attached to the AF base 102. The OIS magnets may be provided on two sides of the lens holder 106 in order to attain rotation about two axes, or may be provided on three sides of the lens holder 106 in order to attain rotation about three axes. One or more of the OIS magnets may be shared with the AF mechanism. (That is, one or more of the OIS magnets may also be used as AF magnets.) Such a shared magnet may be referred to as an AF-OIS magnet or an OIS-AF magnet. For example, the OIS magnets may be provided on three sides among the four sides of the AF base 102, of which one may also be used as an AF magnet. Further, another AF magnet (e.g., a magnet dedicated for AF and not used for OIS) may be provided on the fourth side (see FIG. 2). The present application is not limited in this respect.

The OIS magnets may also be used as position detection magnets used for determining/detecting a tilt direction (a rotational position, an angular position, and an orientation) of the camera module 116. The OIS magnets used both for driving a tilt and for position detection may be referred to as magnets for driving and position detection. (It may simply be referred to as magnets for driving or magnets for position detection when only one of the functionalities is being discussed.)

The camera module 116 may be held on a drive holder 114. The camera module 116 may be attached to the sensor FPC 115, the whole of which may be attached to the drive holder 114. The sensor FPC 115 may be used for providing electric power to or for exchanging signals with one or more components directly or indirectly attached to the movable drive holder 114 (e.g., components such as the image sensor 101, the AF coils 105, and the AF sensors). Providing electricity to the AF coils 105 movable with respect to the drive holder 114 for AF is already described above. Use of an FPC in providing electricity to the components directly or indirectly attached to the drive holder 114 allows electrical connection while the drive holder 114 is movable for OIS. Slits may be provided in the sensor FPC 115, which may reduce reactionary force from the FPC occurring when the camera module moves for OIS. It should be noted that slits are not mandatory, and the present application is not limited in this respect.

The drive holder 114 that holds the camera module 116 may have a bottom part including a generally spherical portion 310. The base 110 of the actuator 100 may have a receiving surface 320 having a portion with a shape corresponding to the generally spherical portion of the bottom part of the drive holder 114. The present application is not limited in this respect. The bottom part of the drive holder 114 and the receiving surface of the base 110 form a sliding mechanism that constrains movement of the camera module to be three-axis rotation about the center of the sphere (that is, the sphere defined by the generally spherical portion of the bottom part of the drive holder 114). The generally spherical portion 310 of the bottom part of the drive holder 114 and the portion of the receiving surface 320 of the base 110 with the corresponding shape may form spherical zones or bands (see FIG. 3). The present application is not limited in this respect.

The base 110 may have ball bearings 112 (see FIG. 3) to facilitate sliding movement between the receiving surface of the base 110 and the bottom part of the drive holder 114.

To press the bottom part of the drive holder 114 against the receiving surface of the base 110, one or more suction magnets 113 may be provided on the bottom part of the drive holder 114, and one or more suction yokes 111 for attracting the suction magnets 113 may be provided on the base 110. The suction magnets 113 may be permanent magnets. The suction yokes 111 may be ferromagnetic pieces such as iron pieces. Attracting force between the suction magnets 113 and the suction yokes 111 allows the drive holder 114 to rotate with its bottom being kept in contact with the receiving surface of the base 110. For example, the movement of the drive holder 114 may be constrained to be rotation about the center of the sphere defined by the spherical portion of the bottom part of the drive holder. The rotation may be two-dimensional rotation or three-dimensional rotation. Such a rotation mechanism does not require members that constrain the rotation to be a single-axis rotation about a specific axis. (Such members include but is not limited to an axle, members that rotatably fix two points of the object-to-be-rotated (e.g., circular or spherical holes and members that rotate therein), or a circular member that guides rotation.) It should be noted that the embodiment as illustrated here with the suction magnets 113 on the drive holder 114 and the suction yokes 111 on the base 110 is advantageous in being free of magnetic interference because there is no relative movement between the driving magnets 103 and the suction magnets 113, but the present application is not limited in this respect. The present application also contemplates embodiments wherein the suction yokes are provided on the drive holder and the suction magnets are provided on the base.

The rotation of the drive holder 114 may be achieved by an electromagnetic interaction between the OIS magnets (also referred to as magnets for driving and position detection) attached to the base 102 of the camera module 116 held on the drive holder 114 and the OIS coils 118 (also referred to as driving coils, coils for driving, or the like, not to be confused with the AF coils 105) attached to the base 110 of the overall actuator 100. The OIS coils 118 may be paired with the OIS magnets (magnets for driving and position detection) of the camera module 116 (e.g., there is an OIS coil for each OIS magnet). The OIS coils 118 may be located on at least three sides of the base 110, but do not need to be directly attached to the base 110. Instead, the OIS coils 118 may be attached to an FPC 117, which may be attached to the base 110. As used herein, unless otherwise stated, the expression “attached to” or other similar expressions may encompass being directly attached as well as being indirectly attached via another member.

The FPC 117 may be used to supply a current to the OIS coils 118. The FPC 117 may be attached to a cover 122 via an FPC frame 121, and the cover 122 may in turn be attached to the base 110. Such a structure facilitates assembly, but the present application is not limited in this respect.

Detection sensors 119 may be attached to the base 110 at locations facing the OIS magnets (magnets for driving and position detection) 103 to detect positions of the respective OIS magnets. Specifically, the detection sensors 119 may be attached to the FPC 117. The detection sensors 119 may be used to measure the rotational positions of the OIS magnets 103, wherein the OIS magnets 103 may be driven to direct the optical axis of the camera module to a desired direction in OIS operations. The detection sensors 119 may be Hall sensors, but the present application is not limited in this respect.

In a generic embodiment, the actuator of the present application may be described as: an actuator for driving a camera module, the actuator including:
a camera module comprising at least a lens holder, the camera module having magnets for driving and position detection provided on at least three sides of the four sides of the camera module;
a drive holder for holding the camera module, wherein the drive holder has a bottom part including a generally spherical portion, and wherein one or more suction magnets or one or more suction yokes are attached to the bottom part;
a base having a receiving surface with a shape corresponding to the generally spherical portion of the bottom part of the drive holder, wherein the receiving surface has one or more suction yokes for attracting the suction magnets or one or more suction magnets for attracting the suction yokes, and wherein the receiving surface and the bottom part of the drive holder form a spherical sliding mechanism that constrains movement of the camera module to be three-axis rotation around a center of a sphere of which the generally spherical portion forms a part;
at least three driving coils fixed with respect to the base, respectively paired with the magnets for driving and position detection provided on the at least three sides of the camera module, for driving the camera module for three-axis rotation; and
detection sensors fixed with respect to the base, respectively arranged at locations facing the magnets for driving and position detection provided on the at least three sides of the camera module, for detecting positions of the respective magnets for driving and position detection.

Such a three-axis rotation mechanism can constrain movement of the camera module to be three-axis rotation around a center of a sphere of which the generally spherical portion of the drive holder forms a part, without requiring members that constrain the rotation to be a single-axis rotation around a specific axis. (Such members include but is not limited to an axle, members that rotatably fix two points of the object-to-be-rotated (e.g., circular or spherical holes and members that rotate therein), and a circular member that guides rotation.)

Such a three-axis rotation mechanism may be made smaller because it does not have a layered structure. A layered structure may be a structure including a first rotation mechanism that supports an object-to-be-rotated (e.g., a drive holder) rotatably about a first axis, a second rotation mechanism that supports the first rotation mechanism rotatably about a second axis, and a third rotation mechanism that supports the second rotation mechanism rotatably about a third axis. Such a layered structure tends to increase the size of the actuator.

Even with a layered structure, it might be possible to increase the number of detection sensors or provide detection sensors for each layer to overcome or alleviate some of its disadvantageous. However, the single-layer three-axis rotation mechanism of the present application can decrease the number of parts/components and reduce the size of the actuator.

Sharing magnets both for driving a tilt and for detecting rotational positions (that is, using at least one magnet both for driving a tilt and for position detection) can also decrease the number of parts/components and reduce the size of the actuator as compared with embodiments providing separate magnets for driving and for position detection.

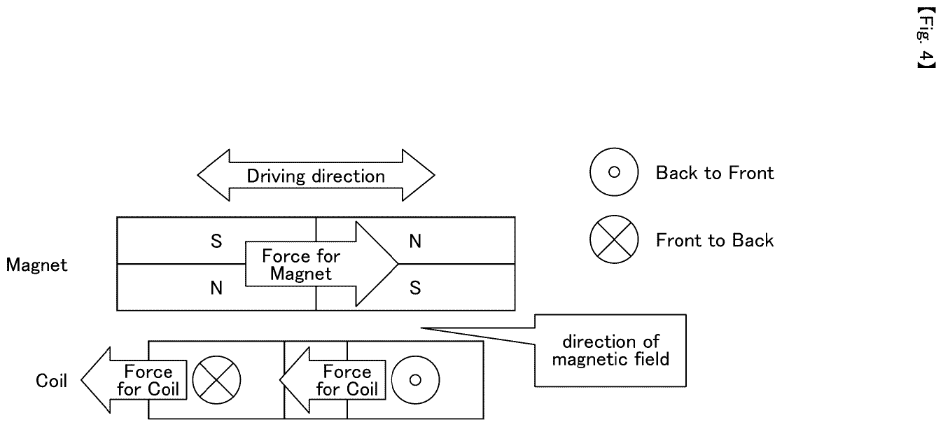

Now, with reference to FIG. 4, the following describes basic principles of an embodiment of a voice coil motor (VCM) used for driving in AF and OIS.

FIG. 4 is a schematic cross-section diagram illustrating principles of a typical VCM. A voice coil motor (VCM) is an actuator causing a coil to make a translational movement in a magnetic field created by a magnet (or causing a magnet to make a translational movement relative to a coil, if the coil is fixed). While the term voice coil motor is historically derived from a voice coil attached to a diaphragm of a loudspeaker, applications of VCM are not limited to loudspeakers, and a VCM may be used in any setting in which a translational movement is desired. A VCM may also be used for causing a rotational movement (e.g., by providing a mechanism to constrain movement to rotation), as described below.

For example, the magnet of FIG. 4 may correspond to one of the OIS magnets, AF magnets, or AF-OIS magnets as illustrated in FIG. 1 or FIG. 3, and, correspondingly, the coil of FIG. 4 may correspond to one of the OIS coils or AF coils as illustrated in FIG. 1 to FIG. 3. However, applications are not limited to these specific embodiments.

In one embodiment, a VCM comprises a magnet and a coil facing each other. The magnet comprises first and second elongated flat members adjacent to each other (e.g., the first member on the left and the second member on the right as in FIG. 4), with magnetic poles occurring on front and back surfaces (e.g., the upper and lower surfaces in FIG. 4) of the first and second elongated flat members. The first elongated flat member has an opposite polarity from the second elongated member. The coil comprises a first substantially straight interval that faces and is substantially parallel with the first elongated flat member of the magnet (a left conductor interval in FIG. 4) and a second substantially straight interval that faces and is substantially parallel with the second elongated flat member of the magnet (a right conductor interval in FIG. 4). In FIG. 4, the first and second intervals of the coil are illustrated as a circle indicative of an electric current flowing into the paper (i.e., from front to back of the paper) and a circle indicative of an electric current flowing out of the paper (i.e., from back to front of the paper).

When an electric current flows through the coil, the first substantially straight interval of the coil experiences a force from the first elongated flat member of the magnet, and the second substantially straight interval of the coil experiences a force from the second elongated flat member of the magnet. As a matter of course, from a perspective of a fixed coil, one may also say that the first elongated flat member of the magnet experiences a force from the first substantially straight interval of the coil, and the second elongated flat member of the magnet experiences a force from the second substantially straight interval of the coil. Whether to fix the coil or the magnet depends on an actual application and is not limited herein. It should be noted that since application of force is relative, an expression “a coil experiences a force from a magnet” is interchangeably used with an expression “a magnet experiences a force from a coil.”

It should be noted that a VCM is not limited to the embodiments illustrated herein, and that any other suitable configuration may be employed. The present application is not limited in this regard. It should be noted that the polarity of the magnet and the polarity of the electric current are not limited to those illustrated.

Conductors of the coil illustrated in FIG. 4 experience a leftward force according to Fleming's left-hand rule. (While the two substantially straight intervals have electric currents in opposite directions, the polarity of the elongated flat magnets facing the conductors is also opposite. Hence, the two conductors experience the force in the same direction.) Since this force is a result of interaction between the coil and the magnet, the coil experiences a leftward force when the magnet is fixed, while the magnet experiences a rightward force when the coil is fixed.

With the arrangement of the OIS coils and OIS magnets as illustrated in FIG. 2, the OIS magnet 103b experiences a force in the Z direction. Because movement of the drive holder 114 is constrained to be rotation about a center of the sphere defined by the spherical portion of its bottom part, this results in rotation about the Y axis (the Z direction corresponds to the tangential direction of the rotation). Similarly, the OIS magnet 103c, arranged in a (vertical) orientation perpendicular to the (horizontal) orientation of the OIS magnet 103b, experiences a force in the Y direction, which results in rotation about the Z axis (the Y direction corresponds to the tangential direction of the rotation). Similarly, the OIS magnet 103a again experiences a force in the Z direction, which results in rotation about the X axis (the Z direction corresponds to the tangential direction of the rotation).

In the embodiment as illustrated in FIG. 2, the OIS magnet 103b is arranged in a horizontal orientation and is responsible for rotation about the Y axis, whereas the OIS magnet 103c is arranged in an vertical orientation and is responsible for rotation about the Z axis (these result in rotation of a line connecting the centers of the OIS magnets 103b and 103c). However, the present application is not limited in this regard. The OIS magnet 103b may be arranged in a vertical orientation for rotation about the Z axis, whereas the OIS magnet 103c may be arranged in a horizontal orientation for rotation about the Y axis.

In an embodiment, the centers of the OIS magnets 103b and 103c may be arranged at point-symmetric locations with respect to the center of rotation (i.e., the center of the sphere defined by the spherical portion of the bottom part of the drive holder). Further, the center of the OIS magnet 103a may be located, in a plane that includes a line segment connecting the centers of the OIS magnets 103b and 103c and that is perpendicular to a central axis of the drive holder, on a perpendicular bisector of the line segment connecting the centers of the OIS magnets 103b and 103c.

In a generic embodiment, the actuator of the present application may further include the following features: centers (P, P′) of first and second magnets for driving and position detection of the magnets for driving and position detection moving with the drive holder are at point-symmetric locations with respect to the center (O) of the sphere, and
wherein a center (Q) of a third magnet for driving and position detection of the magnets for driving and position detection is located, in a plane that includes a line segment connecting the centers (P, P′) of the first and second magnets for driving and position detection and that is perpendicular to a central axis of the drive holder, on a perpendicular bisector of the line segment connecting the centers (P, P′) of the first and second magnets for driving and position detection.

In a generic embodiment, the actuator of the present application may further include the following features: the first and second magnets for driving and position detection (103b, 103c) are for rotation about a first axis and second axis (Y, Z) perpendicular to each other,
wherein a first detection sensor of the detection sensors arranged at a location facing the first magnet for driving and position detection (103b) is configured detect a rotational position around the first axis (Y), and
wherein a second detection sensor of the detection sensors arranged at a location facing the second magnet for driving and position detection (103c) is configured detect a rotational position around the second axis (Z),
whereby a direction of an axis connecting the centers (P, P′) of the first and second magnets for driving and position detection is detected two-dimensionally.

This structure provides a specific arrangement of magnets for position detection and sensors to directly detect the two-dimensional rotational position of the object-to-be-rotated (e.g., a drive holder) in a single layer without relying on a layered structure.

In a generic embodiment, the actuator of the present application may further include the following features: the third magnet for driving and position detection (103a) is for rotation about a third axis (X) perpendicular to the first axis and the second axis (Y, Z),
wherein a third detection sensor of the detection sensors arranged at a location facing the third magnet for driving and position detection (103a) is configured detect a rotational position around the third axis (X), whereby a rotational position of the drive holder around the axis connecting the centers (P, P′) of the first and second magnets for driving and position detection is detected.

This structure provides a specific arrangement of magnets for detection and sensors to directly detect the three-dimensional rotational position of the object-to-be-rotated (e.g., a drive holder) in a single layer without relying on a layered structure.

The reference signs in parentheses in the above generic embodiments refer to FIG. 9, but the embodiments are not limited to those illustrated. Further details on position detection with sensors will be described below.

The sides among the four sides of the camera module on which coils and magnets are arranged are not limited to embodiments as illustrated in FIG. 1 to FIG. 3.

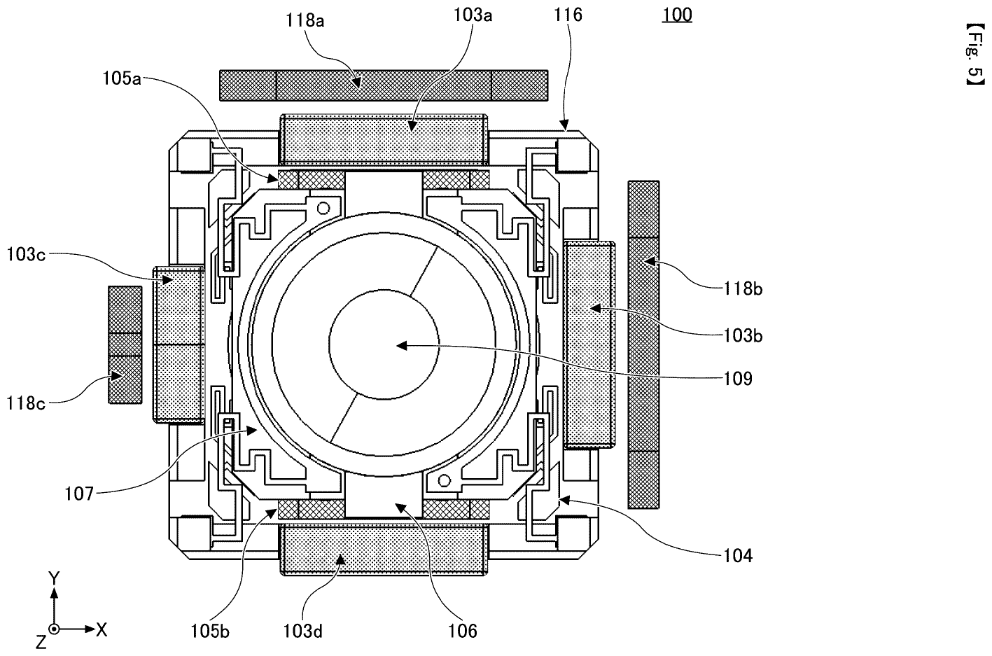

FIG. 5 is a top view of the actuator arrangement as illustrated in FIG. 1 to FIG. 3. The OIS magnets (103a, 103b, 103c) are arranged on three sides, and three OIS coils (118a, 118b, 118c) are arranged facing them. The OIS magnet 103a also serves as an AF magnet, and another AF magnet 103d is provided on the side opposite the OIS-AF magnet 103a. AF coils 105a and 105b are arranged on sides of the lens holder, facing these AF magnets.

FIG. 6 is a top view of another actuator arrangement. The OIS magnets (103a, 103b, 103c) are arranged on three sides, and three OIS coils (118a, 118b, 118c) are arranged facing them. The OIS magnet 103a also serves as an AF magnet, and an AF coil 105a is arranged on a side of the lens holder, facing this AF magnet. No magnet or coil is provided on the side opposite the OIS-AF magnet 103a. In the illustrated embodiment, shafts 126 constrain movement of the lens holder in the direction of the optical axis, but the number and arrangement of the shafts are not limited to those illustrated. Moreover, the embodiments are not limited to ones providing shafts. The lens holder may be supported, without shafts, by a top spring and a bottom spring as illustrated in FIG. 1.

FIG. 7 is a top view of yet another actuator arrangement. The OIS magnets (103a, 103b, 103c) are arranged on three sides, and three OIS coils (118a, 118b, 118c) are arranged facing them. Two of the OIS magnets 103a and 103b also serve as AF magnets, and AF coils 105a and 105c are arranged on two sides of the lens holder, facing the AF magnets. No magnet or coil is provided on the side opposite the OIS-AF magnet 103a. In the illustrated embodiment, shafts 126 constrain movement of the lens holder in the direction of the optical axis, but the number and arrangement of the shafts are not limited to those illustrated. Moreover, the embodiments are not limited to ones providing shafts. The lens holder may be supported, without shafts, by a top spring and a bottom spring as illustrated in FIG. 1.

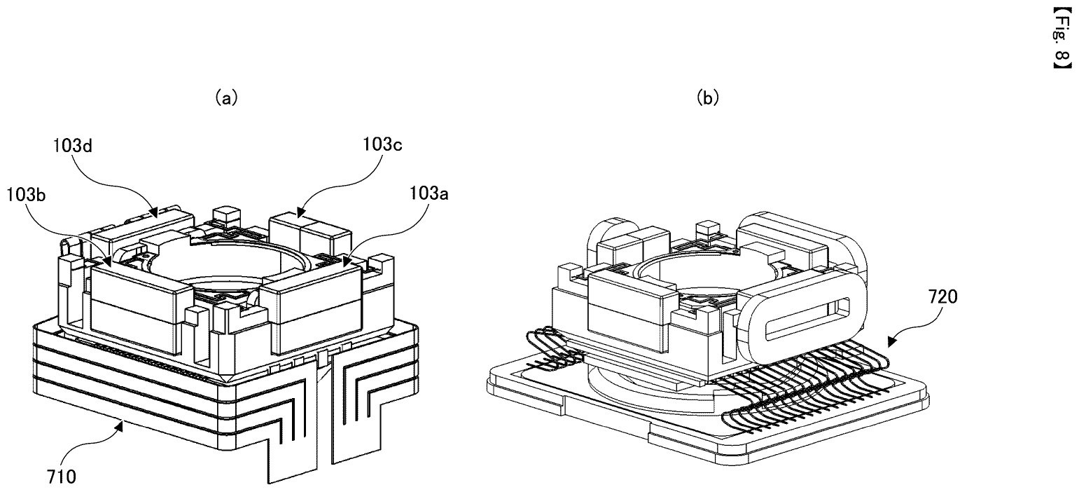

FIG. 8 illustrates example embodiments of external connection to supply power to the movable camera module held on the drive holder. The power supplied may be used by an image sensor of the camera module, and may further be supplied (e.g., via the bottom spring 104) to the AF coils for AF driving.

FIG. 8 (a) illustrates FPC 710, which may correspond to FPC 115 illustrated in FIG. 1 and FIG. 2. (FIG. 8 (a) is a view from the opposite direction with respect to FIG. 2.) The FPC 710 has slits, which may reduce the reactionary force exerted by the FPC 710 on the object-to-be-rotated (e.g., the camera module) in XYZ driving (i.e., when the object-to-be-rotated is driven in three-axis rotation).

FIG. 8 (b) illustrates an embodiment, in which the camera module is supplied with power via metal springs 720 instead of the FPC 710.

The foregoing describes example embodiments of a mechanism for three-axis rotation of an object-to-be-rotated such as a camera module or a drive holder. Now, the following describes embodiments of a position detection mechanism for use in controlling rotational position of the object-to-be-rotated. The position detection mechanism may comprise magnets for driving and position detection (OIS magnets) 103 that move with the drive holder 114 and detection sensors 119 for detecting their positions. The detection sensors 119 are paired with the magnets (i.e., there is a detection sensor for position detection of each magnet), but are fixed with respect to the base 110 of the actuator.

In FIG. 9, (a)-(c) illustrate principles of determining three-dimensional rotational position of an object-to-be-rotated (a movable unit) such as the camera module or the drive holder. The positions P, P′, and Q to be detected by the sensors correspond to the centers of the magnets for driving and position detection 103. A center of a magnet may be a geometrical center of the magnet in a principal plane of the magnet. Movement of P, P′, and Q is constrained (e.g., by the above-mentioned spherical sliding mechanism) to three-axis rotation about a center O (e.g., a center defined by the spherical portion of the bottom part of the drive holder).

As illustrated in FIG. 9 (a), P and P′ are at point-symmetric locations with respect to the center O on the X axis. P is rotated about the Y axis (by a force along the Z direction, which is the tangential direction of the rotation). P′ is rotated about the Z axis (by a force along the Y direction, which is the tangential direction of the rotation). Q is located, in a plane that includes a line segment connecting P and P′ and that is perpendicular to a central axis of the drive holder (e.g., in the XY plane in the state as illustrated in FIG. 9 (a)), on a perpendicular bisector of the line segment connecting P and P′ (e.g., on the Y axis in the state as illustrated in FIG. 9 (a)).

The detection sensors paired with P′ and Q are illustrated as small cubes. (The detection sensor paired with P′ is not shown.) While each of these sensors may only one-dimensionally measure the position of the magnet paired with the sensor, measurements of the three detection sensors may be combined to determine the three-dimensional rotational position of the object-to-be-rotated (e.g., the camera module).

The detection sensors paired with P and P′ can measure the position of P in the Z direction and the position of P′ in the Y direction, respectively. The position information from these detection sensors allows determination of the direction of the line passing through P and P′. In other words, the current rotational position of the object-to-be-rotated can be represented two-dimensionally. The direction of the line passing through P and P′ can thus be completely determined in two dimensions, but a rigid body such as a camera module may undergo three-dimensional rotation, which further involves rotation about the line passing through P and P′. Thus, the necessary and sufficient information of the three-axis rotational position of the camera module 116 may be obtained from position information in three dimensions including the two-dimensional position information from detecting P and P′ as well as one dimensional information from detecting Q.

As illustrated in FIG. 9 (b), the movement of the point P movable with the drive holder 114 (and hence, the camera module 116) to a freely determined location has two degrees of freedom. Seen in the direction of the X axis, the movement of the point P may be represented as movement in two dimensions as illustrated in the inset. After establishing the position of P, however, there remains a degree of freedom for rotation about the axis OP. Thus, the position of Q needs yet to be determined. As illustrated in FIG. 9 (c), with the rotational axis OP fixed, movement of Q is substantially limited to the vertical direction (e.g., either to move upward or move downward). Therefore, further determination of the vertical position of Q uniquely determines the positions of P, P′, and Q. That is, the orientation of the drive holder 114 (and hence, the camera module 116) is uniquely determined.

Thus, two-dimensional position detection for determination of the direction of the axis through P-O-P′ and one-dimensional position detection for determination of the direction of the axis through OQ are sufficient for three-axis rotational position detection. To achieve such three-dimensional position detection, the detection sensors 119 for detecting positions of respective magnets for driving and position detection (OSI magnets) 103 may be provided at locations facing the magnets for driving and position detection 103.

Feedback from the three-dimensional rotational position detection allows controlling the rotation to direct the drive holder 114 (and hence, the camera module 116) to a desired direction. Specifically, it is achieved by controlling electric currents through the OIS coils.

The desired direction as referred to in the previous paragraph is a direction with respect to the housing (e.g., the base 110) of the actuator. In order to determine the desired direction for OIS in the context of camera shake compensation in the real world, one needs to determine the posture/orientation, relative to the external space (e.g., coordinate space fixed to the ground or floor), of the camera in which the actuator is installed (or of a mobile phone or a smartphone in which the camera is installed). This allows keeping the optical axis of the camera module at a constant direction relative to the external space and taking a high-quality image with no or reduced blur due to camera shake, even if the camera moves during an exposure.

Specifically, the three-axis orientation/posture of the camera relative to the external space and the three-axis direction of the drive holder 114 (camera module 116) relative to the camera may be used to determine how to rotate the drive holder 114 (camera module 116) relative to the camera in order to align the optical axis with a desired direction in the external space. Alternatively, a change in the three-axis orientation/posture of the camera relative to the external space may be used to determine how to rotate the drive holder 114 (camera module 116) relative to the camera in order to compensate for the change.

The following describes how to determine the three-axis orientation/posture (which may be referred to as a target rotational position below) of the camera (actuator) relative to the external space. Detection of the orientation of the actuator may be performed with, for example, a gyrosensor. Use of a gyrosensor is advantageous because a gyrosensor is included in many mobile devices (e.g., smartphones). Embodiments of the present application may include a gyronsensor or may merely include an interface that may receive a signal from an external gyrosensor. The present application is not limited in this regard.

Now, the following describes a posture detection mechanism to determine an orientation of the actuator that includes the camera module (e.g., to determine the target rotational position).

The orientation may be obtained by the following iterative formula from information from the gyrosensor:

$${\vec{v}}_{n + 1} = [ \text{} \begin{matrix}{n}_{1}^{2} ( 1 - cos θ ) + & {n}_{1} {n}_{2} ( 1 - cos θ ) + & {n}_{1} {n}_{3} ( 1 - cos θ ) - \\ cos θ & {n}_{3} sin θ & {n}_{2} sin θ \\ {n}_{1} {n}_{2} ( 1 - cos θ ) - & {n}_{2}^{2} ( 1 - cos θ ) + & {n}_{2} {n}_{3} ( 1 - cos θ ) + \\ {n}_{3} sin θ & cos θ & {n}_{1} sin θ \\ {n}_{1} {n}_{3} ( 1 - cos θ ) + & {n}_{2} {n}_{3} ( 1 - cos θ ) - & {n}_{3}^{2} ( 1 - cos θ ) + \\ {n}_{2} sin θ & {n}_{1} sin θ & cos θ\end{matrix} \text{} ] {\vec{v}}_{n} , \qquad ( 1 )$$

wherein \vec{v}ₙ and \vec{v}ₙ₊₁ are vectors indicating an orientation of the actuator at time points n and n+1, respectively, where the subscript n=1, 2, 3, . . . correspond to data acquisition time points in each sampling cycle. The vector [n₁, n₂, n₃]^{T} is a unit vector in a direction of an angular velocity vector obtained from the gyrosensor. The angular velocity vector has a magnitude and a direction that vary over time in general. The direction of the angular velocity vector indicates a direction of a rotation axis at the moment (a direction of the instantaneous rotation axis), and a magnitude of the angular velocity vector indicates a magnitude of the angular velocity about the rotation axis at the moment (an instantaneous magnitude of the angular velocity about the instantaneous rotation axis). The variable θ is a rotation angle from time point n to n+1. The interval between these time points is denoted Tₛ. The relations between relevant variables are illustrated in FIG. 10.

Because the time interval of sampling with the gyrosensor (sampling period) is sufficiently short in many cases, the following formula for small rotation angles θ may be applicable:

$${\vec{v}}_{n + 1} = {\vec{v}}_{n} + {T}_{s} [ \begin{matrix}{ω}_{x} \\ {ω}_{y} \\ {ω}_{z}\end{matrix} ] \times {\vec{v}}_{n} \qquad ( 2 )$$

The second term on the right hand side, indicating a displacement of \vec{v}ₙ, is a vector with a magnitude proportional to |θ|=|\vec{ωᵣ}|·Tₛ and with a direction perpendicular to both the orientation vector of the object-to-be-rotated \vec{v}ₙ and a vector representing the axis of rotation \vec{ωᵣ} (or \vec{n}). That is, the direction of the displacement is the tangential direction of a circle passing through the tip of \vec{v}ₙ in a plane perpendicular to \vec{ωᵣ}. The relations of these directions are illustrated in FIG. 11, in which the small angle θ is exaggerated for illustration.

Regardless of whether to use the exact formula (1) or the approximate formula (2), by repeating in rapid succession (i.e., with a short period) the steps of detecting a change in orientation and rotating the optical axis of the camera module relative to the camera housing to compensate for the change, the direction of the optical axis can be kept constant relative to the external space (e.g., relative to the ground or floor), and high-quality image with no or reduced blur due to camera shake may be obtained. As a matter of course, after the desired direction of the camera module to compensate for the change in orientation, rotations about the respective axes required to attain the desired direction, and thus currents to be caused to flow through the respective OIS coils 118, need to be determined.

It should be noted that when the coordinate system for camera position detection and the coordinate system for the gyrosensor are different, a coordinate transformation is applied to \vec{ωᵣ} or as appropriate.

The simultaneous calculation for the three axes as described above is free of a concept of crosstalk by definition. In other words, its calculation principles do not require considering interrelations of separate rotations in a layered structure of the driving mechanism in determining the three-axis target rotational position in the next sampling period (i.e., the orientation vector of the camera in the next sampling period).

The formula (1) is an exact formula, and thus allows accurate position measurement. On the other hand, the formula (2) does not involve trigonometric functions, and thus is suitable for implementation in a device with a limited processing capability such as a portable device (e.g., a camera, a mobile phone, a smartphone, or the like). Either formula may be used depending on requirements of a particular application.

A controller may be provided to perform various operations including detecting the target rotational position (i.e., the orientation vector in the next sampling period) by using information (signals) from the detection sensors (e.g., Hall sensors) for position detection of the OIS magnets and information (signals) from the gyrosensor for orientation determination of the camera module, and controlling the movement (rotation) of the camera module based on the detected target rotational position. The controller may be provided outside of the actuator including the camera module. For example, the controller may be provided outside of or inside the unit as illustrated in FIG. 2. However, the present application is not limited in this respect.

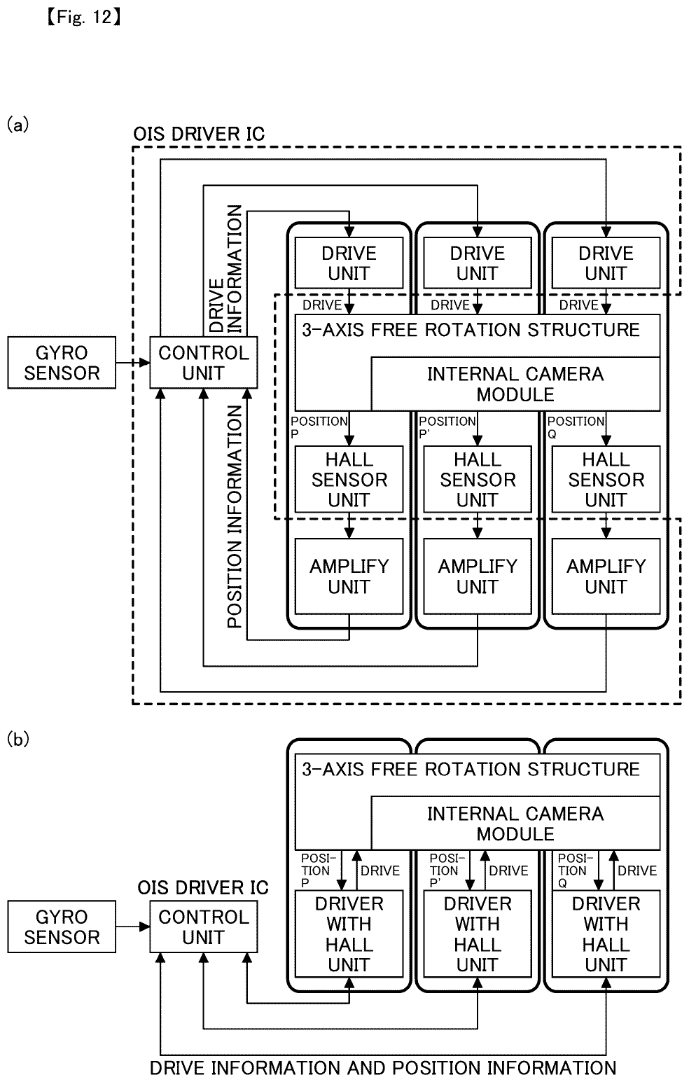

FIG. 12 illustrates relations among the actuator (also referred to as a three-axis free rotation structure here), the detection sensors (e.g., Hall sensor units or Hall units), the gyrosensor, and the controller according to embodiments of the present application.

In an embodiment as illustrated in FIG. 12 (a), the controller is an optical image stabilization (OIS) driver IC. The OIS driver IC includes driving units (drive units) configured to control currents flowing through the driving coils to drive the magnets for driving and position detection (OIS magnets) 103. The OIS driver IC also includes a control unit configured to receive position information from the detection sensors (e.g., Hall sensor units) and information from the gyrosensor, determine orientation information of the actuator based on the information from the gyrosensor, determine driving information based on the position information and the orientation information, and provide the driving information to the driving units. Because output signals from sensors are typically small, amplification units (amplify units) to amplify these signals may be provided for accurate measurement.

In an embodiment as illustrated in FIG. 12 (b), each of the detection sensors is contained in a corresponding driver IC (a driver with a Hall unit) configured to perform both position detection and driving of the corresponding magnet for driving and position detection (OIS magnets) 103. The controller (OIS control IC) is configured to receive position information from the driver ICs and information from the gyrosensor, determine orientation information of the actuator based on the information from the gyrosensor, determine driving information based on the position information and the orientation information, and provide the driving information to the driver ICs.

Some of the various functions as described above may be implemented in a form of a computer program for causing a processor or a computing device to perform one or more functions. The processor or the computing device may correspond to the controller or the control unit as described with reference to FIG. 12.

In one example, the functions performed by a processor or a computer device may be described as a method or a process for controlling the actuator according embodiments of the present application, the method comprising: receiving three-axis rotation position information from the detection sensors; determining a required rotation to compensate for a change of an optical axis direction due to a change in orientation of the actuator based on the three-axis rotational position information and orientation information of the actuator; and controlling rotation of the camera module based on the required rotation. Various other functions described in the foregoing may also be applicable to the method.

Various signal processing and control functions (including those for AF and OIS) may be implemented as a computer program. The computer program may be embodied on a non-transitory computer-readable storage medium. The storage medium may be any medium that can store a computer program and may be a solid-state memory such as a USB drive, a flash drive, a read-only memory (ROM), and a random-access memory (RAM); a magnetic storage medium such as a removable or non-removable hard disk; or an optical storage medium such as an optical disc.

The actuator for free-angle rotation for OIS or a controlling method thereof according to the present application may be implemented in a camera system. Such a camera system may be implemented in a mobile device such as a mobile phone or a smartphone.

While various embodiments are described above and illustrated in the drawings, the present invention is not limited to the specific embodiment described or illustrated.

The unit division disclosed in embodiments of the present application is not limiting, and embodiments may be configured with other divisions of components.

The foregoing descriptions are merely to illustrate various embodiments of the present application, and are not intended to limit the scope of the invention. Any variation that would readily occur to a person skilled in the art in view of the present disclosure shall fall within the scope of this application. For example, measures separately disclosed may be combined in a single embodiment as appropriate, as long as such measures are not mutually exclusive.

Any reference signs in the claims shall not be construed as limiting the extent of the claimed invention.

What is claimed is:

1. An actuator comprising:
a camera module comprising at least a lens holder, the camera module having magnets for driving and position detection, wherein the magnets are provided on at least three sides of four sides of the camera module;
a drive holder configured to hold the camera module, wherein the drive holder has a bottom part including a generally spherical portion, and wherein one or more suction magnets or one or more suction yokes are attached to the bottom part;
a base having a receiving surface with a shape corresponding to the generally spherical portion of the bottom part of the drive holder, wherein the receiving surface has the one or more suction yokes for attracting the one or more suction magnets or has the one or more suction magnets for attracting the one or more suction yokes, and wherein the receiving surface and the bottom part of the drive holder form a sliding mechanism configured to constrain movement of the camera module to three-axis rotation around a center of a sphere of which the generally spherical portion forms a part;
at least three driving coils fixed with respect to the base, the at least three driving coils respectively paired with the magnets for driving and position detection provided on the at least three sides of the camera module, wherein the at least three driving coils are configured to drive the camera module for three-axis rotation; and
detection sensors fixed with respect to the base, the detection sensors respectively arranged at locations facing the magnets for driving and position detection provided on the at least three sides of the camera module, wherein the detection sensors are configured to detect positions of the respective magnets for driving and position detection.

2. The actuator according to claim 1, wherein:
centers of first and second magnets for driving and position detection of the magnets for driving and position detection are at point-symmetric locations with respect to the center of the sphere, wherein the first and second magnets for driving and position detection are configured to move with the drive holder; and
a center of a third magnet for driving and position detection of the magnets for driving and position detection is located in a plane that includes a line segment connecting the centers of the first and second magnets for driving and position detection and that is perpendicular to a central axis of the drive holder, and is on a perpendicular bisector of the line segment connecting the centers of the first and second magnets for driving and position detection.

3. The actuator according to claim 2, wherein:
the first and second magnets for driving and position detection are configured to respectively rotate about a first axis and a second axis perpendicular to each other;
a first detection sensor of the detection sensors arranged at a location facing the first magnet for driving and position detection is configured to detect a rotational position around the first axis; and
a second detection sensor of the detection sensors arranged at a location facing the second magnet for driving and position detection is configured to detect a rotational position around the second axis, wherein a direction of an axis connecting the centers of the first and second magnets for driving and position detection is configured to be respectively detected by the first detection sensor and the second detection sensor two-dimensionally.

4. The actuator according to claim 3, wherein:
the third magnet for driving and position detection is configured to rotate about a third axis perpendicular to the first axis and the second axis; and
a third detection sensor of the detection sensors arranged at a location facing the third magnet for driving and position detection is configured to detect a rotational position around the third axis, wherein a rotational position of the drive holder around the axis connecting the centers of the first and second magnets for driving and position detection is configured to be detected by the third detection sensor.

5. The actuator according to claim 1, further comprising a controller configured to control rotation of the camera module to compensate for a change of an optical axis direction due to a change in orientation of the actuator by using both three-axis rotational position information from the detection sensors and orientation information of the actuator.

6. The actuator according to claim 5, wherein the controller is configured to determine the orientation information based on information from a gyrosensor.

7. The actuator according to claim 6, wherein:
the controller is configured to determine the orientation information based on information from the gyrosensor according to an iterative formula:
$${\vec{v}}_{n + 1} = [ \text{} \begin{matrix}{n}_{1}^{2} ( 1 - cos θ ) + & {n}_{1} {n}_{2} ( 1 - cos θ ) + & {n}_{1} {n}_{3} ( 1 - cos θ ) - \\ cos θ & {n}_{3} sin θ & {n}_{2} sin θ \\ {n}_{1} {n}_{2} ( 1 - cos θ ) - & {n}_{2}^{2} ( 1 - cos θ ) + & {n}_{2} {n}_{3} ( 1 - cos θ ) + \\ {n}_{3} sin θ & cos θ & {n}_{1} sin θ \\ {n}_{1} {n}_{3} ( 1 - cos θ ) + & {n}_{2} {n}_{3} ( 1 - cos θ ) - & {n}_{3}^{2} ( 1 - cos θ ) + \\ {n}_{2} sin θ & {n}_{1} sin θ & cos θ\end{matrix} \text{} ] {\vec{v}}_{n} ,$$
wherein \vec{v}ₙ and \vec{v}ₙ₊₁ are vectors indicating an orientation of the actuator at time points n and n+1, respectively, and
wherein the vector [n₁, n₂, n₃]^{T} is a unit vector in a direction of an angular velocity vector obtained from the gyrosensor, with the direction of the angular velocity vector indicating an instantaneous direction of a rotation axis, and a magnitude of the angular velocity vector indicating a magnitude of an instantaneous angular velocity about the rotation axis, wherein θ is a rotation angle from time point n to n+1; or
the controller is configured to determine the orientation information based on information obtained from the gyrosensor according to an approximate iterative formula:
$${\vec{v}}_{n + 1} = {\vec{v}}_{n} + {T}_{s} [ \begin{matrix}{ω}_{x} \\ {ω}_{y} \\ {ω}_{z}\end{matrix} ] \times {\vec{v}}_{n}$$
wherein \vec{v}ₙ and \vec{v}ₙ₊₁ are vectors indicating an orientation of the actuator at time points n and n+1, respectively, and
wherein the vector
$$[ \begin{matrix}{ω}_{x} \\ {ω}_{y} \\ {ω}_{z}\end{matrix} ]$$
is an angular velocity vector obtained from the gyrosensor, × denotes an outer product in algebraic geometry, with Tₛ indicating a time interval from time point n to n+1 and corresponding to a sampling period of the gyrosensor.

8. The actuator according to claim 7, wherein:
the controller is an optical image stabilization (OIS) driver IC comprising:
driving units configured to control currents flowing through the driving coils to drive the magnets for driving and position detection; and
a control unit configured to receive position information from the detection sensors and information from the gyrosensor, determine orientation information of the actuator based on the information from the gyrosensor, determine driving information based on the position information and the orientation information, and provide the driving information to the driving units; or
each of the detection sensors is contained in a corresponding driver IC configured to perform both position detection and driving of the corresponding magnet for driving and position detection, wherein the controller is configured to receive position information from the driver ICs and information from the gyrosensor, determine orientation information of the actuator based on the information from the gyrosensor, determine driving information based on the position information and the orientation information, and provide the driving information to the driver ICs.

9. The actuator according to claim 1, wherein the magnets for driving and position detection provided on the at least three sides of the four sides of the camera module comprise:
a first magnet for driving and position detection provided on a first side, the first magnet for driving and position detection configured to cause rotation about an axis perpendicular to both a normal to the first side and an optical axis of the camera module;
a second magnet for driving and position detection provided on a second side, the second magnet for driving and position detection configured to cause rotation about the optical axis of the camera module; and
a third magnet for driving and position detection provided on a third side, the third magnet for driving and position detection configured to cause rotation about an axis perpendicular to both a normal to the third side and the optical axis of the camera module.

10. The actuator according to claim 1, wherein:
the camera module supports the lens holder, and is configured to allow the lens holder to move along an optical axis for autofocusing (AF);
at least one AF coil is provided on the lens holder; and
at least one AF magnet facing the at least one AF coil is provided on a housing of the camera module.

11. The actuator according to claim 10, wherein at least one of the magnets for driving and position detection provided on the at least three sides is also used as at least one of the at least one AF magnet.

12. The actuator according to claim 10, wherein:
the magnets for driving and position detection provided on at least three sides of the four sides of the camera module are provided on only three sides of the four sides of the camera module; and
one of the magnets for driving and position detection is also used as the at least one AF magnet.

13. The actuator according to claim 12, wherein a further AF magnet is provided on a fourth side of the four sides of the camera module on which the magnets for driving and position detection are not provided.

14. The actuator according to claim 10, wherein:
the magnets for driving and position detection provided on at least three sides of the four sides of the camera module are provided on only three sides of the four sides of the camera module; and
magnets for driving and position detection provided on two sides of the only three sides are also used as that at least one AF magnet.

15. The actuator according to claim 1, wherein:
one or more components directly or indirectly attached to the drive holder are configured to be supplied power from a portion fixed with respect to the base via a second flexible printed circuit (FPC) attached to the drive holder, wherein the second FPC comprises one or more slits; or
the one or more components directly or indirectly attached to the drive holder are configured to be supplied power from a portion fixed with respect to the base via one or more metal springs.

16. The actuator according to claim 15, wherein the one or more components directly or indirectly attached to the drive holder are an image sensor, an AF coil, or an AF sensor.

17. The actuator according to claim 1, wherein the camera module supports the lens holder to be movable along an optical axis for autofocusing (AF) via one or more elastic members.

18. The actuator according to claim 17, wherein:
the one or more elastic members are leaf springs; or
the one or more elastic members comprise both a first leaf spring supporting the lens holder along the optical axis from a first side and a second leaf spring supporting the lens holder along the optical axis from a second side; or
the one or more elastic members comprises a first leaf spring supporting the lens holder along the optical axis from a first side, and wherein movement of the lens holder is constrained to a direction of the optical axis by at least two shafts; or
at least one of the one or more elastic member forms at least part of a path for supplying power to the camera module.

19. The actuator according to claim 10, wherein:
the lens holder is supported by a top spring and a bottom spring to be movable along the optical axis for autofocusing (AF);
the at least one AF coil comprises a first AF coil and a second AF coil; and
a current is configured to be caused to flow from a portion fixed with respect to the base to a second flexible printed circuit (FPC) attached to the drive holder, the bottom spring, the first AF coil, the top spring, the second AF coil, the bottom spring, and the second FPC in this order.

20. A camera system comprising an actuator, wherein the actuator comprises:
a camera module comprising at least a lens holder, the camera module having magnets for driving and position detection, wherein the magnets are provided on at least three sides of four sides of the camera module;
a drive holder configured to hold the camera module, wherein the drive holder has a bottom part including a generally spherical portion, and wherein one or more suction magnets or one or more suction yokes are attached to the bottom part;
a base having a receiving surface with a shape corresponding to the generally spherical portion of the bottom part of the drive holder, wherein the receiving surface has the one or more suction yokes for attracting the one or more suction magnets or has the one or more suction magnets for attracting the one or more suction yokes, and wherein the receiving surface and the bottom part of the drive holder form a sliding mechanism configured to constrain movement of the camera module to three-axis rotation around a center of a sphere of which the generally spherical portion forms a part;
at least three driving coils fixed with respect to the base, the at least three driving coils respectively paired with the magnets for driving and position detection provided on the at least three sides of the camera module, wherein the at least three driving coils are configured to drive the camera module for three-axis rotation; and
detection sensors fixed with respect to the base, the detection sensors respectively arranged at locations facing the magnets for driving and position detection provided on the at least three sides of the camera module, wherein the detection sensors are configured to detect positions of the respective magnets for driving and position detection.
